(19) United States
(12) Patent Application Publication
(10) Pub. No.: US 2011/0080399 A1
(43) Pub. Date: Apr. 7, 2011

(54) System and Method for Creating a Three-Dimensional Virtual Environment

(75) Inventor: Peter Sgromo, Alameda, CA (US)

(73) Assignee: IMPERIAL TOY LLC, North Hills, CA (US)

(21) Appl. No.: 12/898,545

(22) Filed: Oct. 5, 2010

Related U.S. Application Data
(60) Provisional application No. 61/249,092, filed on Oct. 6, 2009.

(51) Int. Cl. A63F 13/00

(52) U.S. Cl. 345/419; 463/32

(57) ABSTRACT

A system for providing a three-dimensional virtual or fantasy environment comprises a viewing device having anaglyph lenses to provide a three-dimensional viewing effect. The viewing device can be a pair of eyeglasses having anaglyph lenses. The system includes a backdrop that may include a support for attaching to a desired structure such as a wall, floor and/or ceiling. The backdrop has themed or scenic artistry from two or more colors superimposed and offset to provide a desired depth effect The backdrop has a central image with a perceived depth different from a surrounding environment. The backdrop can include a light source to provide further visual enhancement for play. The backdrop may be a two-dimensional image on paper, plastic, fabric, or other suitable material. Multiple viewing devices can be provided to permit play by multiple uses at once.

### CROSS-REFERENCE TO RELATED APPLICATIONS

This patent application claims priority from U.S. Provisional Patent Applications 61/249,092 filed on Oct. 6, 2009, which is herein incorporated by reference in its entirety.

### FIELD OF THE INVENTION

This invention relates to a system and method for providing a three-dimensional virtual environment and for games incorporating the same. The system generally comprises an anaglyph viewer and an anaglyph scene backdrop that provides the virtual environment. A game may be played by one or more participants viewing the anaglyph scene through the anaglyph viewer. The anaglyph viewer provides participants to view a two-dimensional anaglyph scene as a three-dimensional scene of which they are a part of.

### SUMMARY OF THE INVENTION

In one embodiment, a system for providing a three-dimensional virtual environment is disclosed. The three-dimensional system comprises an anaglyph viewer and an anaglyph scene backdrop. The anaglyph viewer is preferably a pair of eyeglasses having two lens comprised of different filters or colors, preferably each lens having a chromatically opposite color. The anaglyph scene backdrop may be a two-dimensional image on paper, plastic, fabric, or other suitable material that may be easily mounted or placed on a wall, floor and/or ceiling.

In another embodiment, a virtual reality environment or game is provided utilizing the system for providing a three-dimensional virtual environment. The virtual reality environment or game may be incorporated as part of a single- or multi-player game and incorporates the anaglyph scene or themed backdrops that may be mounted to any one or a combination of a wall, ceiling and floor. The system may optionally further include support structures onto which the anaglyph scene may be mounted. The system may be provided with additional props or accessories to enhance the realism of the scene. The props or accessories may be three-dimensional objects which also have printed thereon an anaglyph image or scene. Additionally, various light sources may be provided on the anaglyph scene, props and accessories. Instructions and game rules may be provided with the game.

A more complete understanding of system and methods disclosed herein will be afforded to those skilled in the art, as well as a realization of additional advantages and objects thereof, by a consideration of the following detailed description. Reference will be made to the appended sheets of drawings which will first be described briefly.

### BRIEF DESCRIPTION OF THE DRAWINGS

FIG. 1 depicts a preferred embodiment of a system for providing a three-dimensional virtual environment.

FIG. 2 depicts a preferred embodiment of an anaglyph viewer.

Throughout the several figures and in the specification that follows, like element numerals are used to indicate like elements appearing in one or more of the figures.

### DETAILED DESCRIPTION OF THE PREFERRED EMBODIMENTS

Disclosed herein systems and methods for providing a three-dimensional virtual environment and for games incorporating the same. The system and methods provide one or more participants with an enhanced visual experience of being a part of a three-dimensional environment by enabling participants to view an anaglyph scene through an anaglyph viewer. The system may further be used in connection with a themed or fantasy game or environment involving single or multiple players.

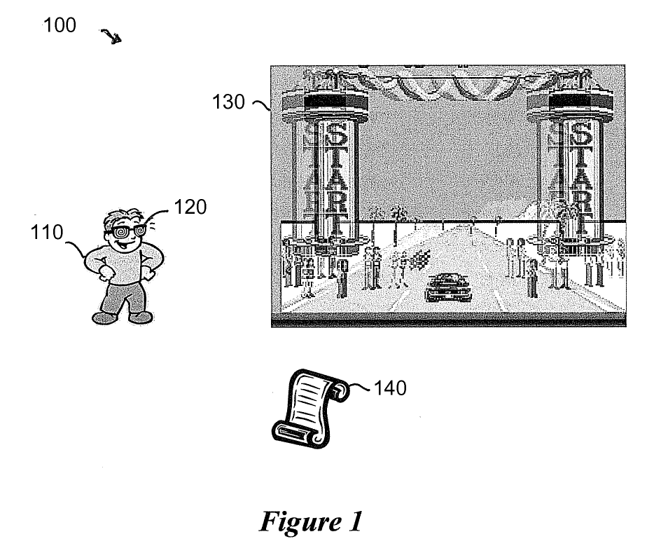

FIG. 1 depicts a preferred embodiment of a system 100 for providing a three-dimensional virtual environment. The system 100 generally comprises an anaglyph viewer 120 that is worn by a user 110 and a corresponding anaglyph scene 130. Instructions 140 may further be provided for using the anaglyph viewer 120, for mounting the anaglyph scene, and/or for game play rules. The system may optionally further include support structures onto which the anaglyph scene may be mounted

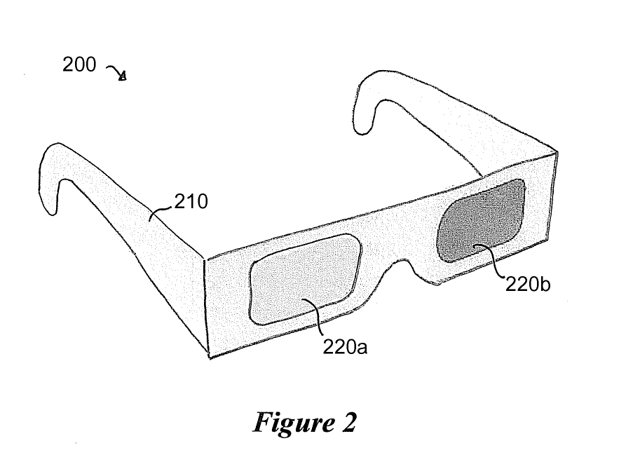

The anaglyph viewer 120 is preferably a pair of eyeglasses having two lens comprised of different filters or colors, preferably each lens having a chromatically opposite color. As further shown in FIG. 2, the anaglyph viewer 200 is preferably configured as a pair of eyeglasses having colored lens 220a, 220b that is supported by a frame 210. The colored lens 220a, 220b are of two different colors, and are preferably opposite colors on the color spectrum (e.g., cyan and red). In the case of a cyan/red anaglyph eyeglass, the red lens over the left eye allows only the red part of the anaglyph image through to that eye, while the cyan lens over the right eye allows only the blue green parts of the image through to that eye. Portions of the image that are red will appear dark through the cyan filter, while portions of the colors composed only of green and blue will appear dark through the red filter. These differences create a perception in the user of depth and thus of a three-dimensional image.

The anaglyph scene backdrop 130 may be a two-dimensional image on paper, plastic, fabric, or other suitable material that may be easily mounted or placed on a wall, floor and/or ceiling. The anaglyph scene backdrop 130 provides a stereoscopic three-dimensional effect when viewed with the two color anaglyph glasses. The images on the anaglyph scene backdrop 130 comprising at least of two color layers, superimposed, but offset with respect to each other to produce a depth effect. Usually, the main subject is in the center, while the foreground and background are shifted laterally in opposite directions. Thus, the anaglyph scene backdrop 130 contains two differently filtered colored images, one for each eye. When viewed through the anaglyph glasses 120, they reveal an integrated stereoscopic image.

Instructions 140 may be provided with the system 100 for describing proper installation, viewing and game play techniques and rules. Thus, the system 100 may be used in connection with a single or multiple player virtual and fantasy environment and game. Additional props and accessories (not shown), such as three-dimensional objects and lights, may be provided to further enhance the virtual or fantasy environment. The scene backdrops may further include any one or a combination of light sources embedded thereon, such that participant(s) wearing the anaglyph viewer 120 are provided with a further enhanced visual experience.

Having thus described preferred embodiments for a system for providing a three-dimensional virtual environment, it should be apparent to those skilled in the art that certain advantages of the within methods and systems have been achieved. It should also be appreciated that various modifications, adaptations, and alternative embodiments thereof may be made without departing from the scope and spirit of the present technology.

What is claimed is:

1. A system for providing a three-dimensional virtual play environment comprising:
an optical viewing device providing an anaglyph optical viewing effect; and
a portable backdrop comprising themed or scenic artistry of two or more colors that are used to provide a desired depth effect;
wherein when the backdrop is viewed by a user through the optical viewing device, the user sees a three-dimensional image that enhances play.

2. The system as recited in claim 1 wherein the optical viewing device comprises a pair of eyeglasses having anaglyph lenses.

3. The system as recited in claim 2 wherein the anaglyph lenses are each of a different color.

4. The system as recited in claim 1 wherein the backdrop comprises a two-dimensional image wherein the colors are superimposed but offset from one another.

5. The system as recited in claim 1 wherein the backdrop is formed from materials selected from the group consisting of paper, plastic, and fabric.

6. The system as recited in claim 1 wherein the three-dimensional image is an integrated stereoscopic image of the different colors as filtered by the optical viewing device.

7. The system as recited in claim 1 wherein the backdrop includes a central image having a different depth perception than a surrounding environment.

8. The system as recited in claim 1 wherein the backdrop includes a light source to provide a further enhanced viewing experience.

9. The system as recited in claim 1 further including rules describing proper game play.

10. The system as recited in claim 1 comprising a number of optical viewing devices worn by multiple users.

11. A system for providing a three-dimensional virtual or fantasy play environment comprising:
a pair of eyeglasses including anaglyph viewing lenses; and
a portable backdrop comprising two-dimensional themed or scenic artistry depicting a desired children's play environment, wherein the artistry is provided using two or more colors that are superimposed and offset from one another to provide a desired depth effect;
wherein when the backdrop is viewed by a user through the optical viewing device, the user sees a three-dimensional image that enhances play.

12. The system as recited in claim 11 wherein the system further includes instructions describing game play techniques and rules.

13. The system as recited in claim 11 wherein the backdrop includes one or more support for attaching to a desired structure.

14. The system as recited in claim 11 wherein the backdrop includes one or more light sources to further enhance play.

15. The system as recited in claim 11 wherein the backdrop colors comprise two differently filtered images, one for each eye.

16. The system as recited in claim 11 wherein the lenses are of a chromatically different color.

17. The system as recited in claim 11 comprising a number of the eyeglasses that are each worn by different users to enable play by multiple users at once.

18. A method for creating a three-dimensional virtual or fantasy play environment comprising the steps of:
providing a backdrop comprising two-dimensional themed or scenic artistry depicting a desired children's play environment, wherein the artistry is provided using two or more colors superimposed and offset from one another to provide a desired depth effect;
wearing eyeglasses having anaglyph lenses that provide a three-dimension optical effect; and
viewing the backdrop during play;
wherein the backdrop as viewed through the eyeglasses provides an three-dimensional environment that enhances play.

19. The method as recited in claim 18 further comprising following instructions that set out game play techniques and rules.

20. The method as recited in claim 18 wherein the backdrop includes one or more support for attaching to a desired structure, and further comprising the step of attaching the backdrop to the desired structure

21. The method as recited in claim 18 wherein the backdrop includes one or more light sources to further enhance play.

22. The method as recited in claim 18 wherein the eyeglasses are worn by a number of different users to enable play by multiple users at once.
